(19) United States
(12) Patent Application Publication
(10) Pub. No.: US 2026/0199782 A1
(43) Pub. Date: Jul. 16, 2026

(54) GAME SIGNAL FEEDBACK METHOD AND APPARATUS, ELECTRONIC DEVICE, AND READABLE STORAGE MEDIUM

(71) Applicant: NETEASE (HANGZHOU) NETWORK CO., LTD., Hangzhou, Zhejiang (CN)

(72) Inventor: Peng SU, Guangzhou, Guangdong (CN)

(73) Assignee: NETEASE (HANGZHOU) NETWORK CO., LTD., Hangzhou, Zhejiang (CN)

(21) Appl. No.: 19/138,245

(22) PCT Filed: May 29, 2023
(86) PCT No.: PCT/CN2023/096912

§ 371 Date: Jun. 12, 2025

(30) Foreign Application Priority Data
Dec. 15, 2022 (CN) 202211616174.1

(51) Int. Cl. A63F 13/52; A63F 13/533; A63F 13/54; G06F 3/01; G06F 3/16

(52) U.S. Cl. CPC A63F 13/52; A63F 13/533; A63F 13/54; G06F 3/016; G06F 3/167

(57) ABSTRACT

An embodiment of the present disclosure comprises: a terminal device displaying a graphical user interface comprising a game scene and a controlled virtual object located in the game scene, the controlled virtual object corresponding to the terminal device; by means of the graphical user interface, displaying a scene thumbnail identifier corresponding to the game scene, the scene thumbnail comprising a scene display area and an indication identifier, and the indication identifier being located at the edge of the scene display area; acquiring a sound source object in the game scene, and controlling to display in the scene display area prompt information corresponding to the sound source object; and, when there is a target object in the game scene, according to orientation information between the controlled virtual object and the target object, controlling a display mode of the indication identifier.

### CROSS REFERENCE TO RELATED APPLICATIONS

The present disclosure is a U.S. National Stage of International Application No. PCT/CN2023/096912, filed on May 29, 2023, which claims the priority of the Chinese patent application with an application number 202211616174.1, and titled by “Game signal feedback method, apparatus, electronic device and readable storage medium”, which was submitted to the China National Intellectual Property Administration on Dec. 15, 2022, the entire contents of both of which are incorporated herein by reference for all purposes.

### TECHNICAL FIELD

The present disclosure relates to the technical field of game processing, and in particular, to a game signal feedback method and apparatus, an electronic device and a computer-readable storage medium.

### BACKGROUND

With the continuous increase of people's pressure, games have gradually become a common form of entertainment for people to relieve stress. In order to help players find target objects such as treasure chests and props, detection tools such as radars are usually used for detection and the detection signals are fed back to the players.

The existing detection signal feedback mode is as follows. After the detection tool conducts detection, the direct and accurate position information of the target object (such as directly displaying an indication line) is directly fed back to the player.

### SUMMARY

In a first aspect, an embodiment of the present disclosure provides a game signal feedback method, where a graphical user interface is displayed through a terminal device, the graphical user interface includes a game scene and a controlled virtual object located in the game scene, and the controlled virtual object corresponds to the terminal device. The method includes: displaying a scene thumbnail identifier corresponding to the game scene through the graphical user interface, where the scene thumbnail includes a scene display area and an indication identifier, the scene display area displays a character identifier corresponding to the controlled virtual object, and the indication identifier is located at an edge of the scene display area; acquiring a sound source object in the game scene, and controlling to display prompt information corresponding to the sound source object in the scene display area; when a target object exists in the game scene, acquiring orientation information between the controlled virtual object and the target object, where the target object is at least one of the following virtual objects: a virtual item and a virtual interactive object located in the game scene, and the virtual interactive object is configured to provide game information in response to an interactive behavior of the controlled virtual object; and controlling a display mode of the indication identifier according to the orientation information. In a second aspect, an embodiment of the present disclosure further provides an electronic device, including a memory which stores a plurality of instructions; the processor loads instructions from the memory to execute any one of the game signal feedback methods provided in the embodiments of the present disclosure. In a third aspect, an embodiment of the present disclosure further provides a computer-readable storage medium, where the computer-readable storage medium stores a plurality of instructions, the instructions are suitable for being loaded by a processor to execute any one of the game signal feedback methods provided in the embodiments of the present disclosure.

### BENEFICIAL EFFECTS

In the embodiments of the present disclosure, in the first aspect, when there is a target object in the game scene, the orientation information between the controlled virtual object and the target object is acquired, and the display mode of the indication identifier at the edge of the scene thumbnail identifier corresponding to the game scene is controlled according to the orientation information. Since the display mode of the indication identifier may be adjusted according to the orientation information, different visual signals can be generated as the orientation information between the controlled virtual object and the target object changes. In this way, information about the location of the target object can be fed back to the player without directly feeding back the location information of the target object, which ensures that the player can accurately and gradually find the target object by using the detection signal, and improves the accuracy of the game signal feedback. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game. In the second aspect, the detection signal is displayed at the edge of the scene thumbnail identifier corresponding to the game scene displayed through the graphical user interface. Since there is no need to occupy additional screen space for the feedback of the game signal, the feedback of the game signal can save screen space, simplify the game interface, especially the game interface of mobile games, thereby improving the simplicity of the game interface, and further improving the convenience of game interaction operations on the basis of providing game signals to the player.

### BRIEF DESCRIPTION OF THE DRAWINGS

In order to more clearly illustrate the technical solutions in the embodiments of the present disclosure, the drawings required for use in the description of the embodiments will be briefly introduced below. Obviously, the drawings described below are only some embodiments of the present disclosure. For those skilled in the art, other drawings can be obtained based on these drawings without creative efforts.

FIG. 1 is a schematic diagram of a game signal feedback system provided by one of the embodiments of the present disclosure;

FIG. 2 is a flowchart of an embodiment of a game signal feedback method provided by one of the embodiments of the present disclosure;

FIG. 3 is a schematic diagram illustrating a target distance and a target angle between a detection object and a target object provided by one of the embodiments of the present disclosure;

FIG. 4 is a schematic scene diagram illustrating a first prompt area of an indication identifier provided by one of the embodiments of the present disclosure;

FIG. 5 is a schematic scene diagram illustrating a second prompt area of the indication identifier provided by one of the embodiments of the present disclosure;

FIG. 6 is an overall schematic diagram illustrating a multi-sensory type information prompt provided by one of the embodiments of the present disclosure;

FIG. 7 is a schematic scene diagram of a scene thumbnail provided by one of the embodiments of the present disclosure;

FIG. 8 is a schematic diagram illustrating a scene thumbnail presenting a working status of a detection tool provided by one of the embodiments of the present disclosure;

FIG. 9 is a schematic structural diagram of a game signal feedback apparatus provided by one of the embodiments of the present disclosure; and

FIG. 10 is a schematic structural diagram of an electronic device provided by one of the embodiments of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure, rather than all the embodiments. Based on the embodiments in the present disclosure, all other embodiments obtained by those skilled in the art without creative efforts shall fall within the protection scope of the present disclosure. Meanwhile, in the description of the embodiments of the present disclosure, terms such as “first” and “second” are only used for distinguishing descriptions and shall not be construed as indicating or implying relative importance. Therefore, a feature defined with “first” or “second” may explicitly or implicitly include one or more of such features. In the description of the embodiments of the present disclosure, the meaning of “a plurality of” is two or more, unless otherwise specifically defined.

The embodiments of the present disclosure provide a game signal feedback method and apparatus, an electronic device, and a computer-readable storage medium. Specifically, the game signal feedback method of the present disclosure may be executed by an electronic device, where the electronic device may be a terminal, a server, or other devices. The terminal may be a smart phone, a tablet computer, a laptop computer, a touch screen, a game console, a personal computer (PC), a personal digital assistant (PDA), or other terminal devices. The terminal may also include a client, which may be a game application client, a browser client carrying a game program, an instant messaging client, or the like. The server may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, CDN, big data, and artificial intelligence platforms.

For example, when the game signal feedback method runs on a terminal, the terminal device stores a game application program and is used for presenting the virtual scene on the game screen. The terminal device is used to interact with the user via a graphical user interface, for example, by downloading and installing a game application program on the terminal device and running it. The terminal device may provide the graphical user interface to the user in various ways, for example, the graphical user interface may be rendered and displayed on a display screen of the terminal, or provided to the player through a holographic projection. For instance, the terminal device may include a touch display screen and a processor. The touch display screen is used to present the graphical user interface and receive operation instructions generated by a user acting on the graphical user interface, where the graphical user interface includes the game screen. The processor is used to run the game, generate the graphical user interface, respond to operation instructions, and control the display of the graphical user interface on the touch display screen.

For example, when the game signal feedback method runs on a server, it may be a cloud game. Cloud game refers to a gaming manner based on cloud computing. In the operation mode of cloud gaming, the main body for running the game application program and the main body for presenting the game screen are separated, and the storage and execution of the game signal feedback method are completed on the cloud gaming server. The cloud gaming client is mainly used for receiving and sending game data and presenting the game screen. For example, the cloud gaming client may be a display device with data transmission function close to the user side, such as a mobile terminal, a TV, a computer, a handheld computer, a personal digital assistant, etc., but the terminal device for processing game data is a cloud gaming server in the cloud. During the gameplay, the user operates the cloud gaming client to send operation instructions to the cloud gaming server. The cloud gaming server runs the game according to the operation instructions, encodes and compresses the game screen and other data, and returns the data to the cloud gaming client via the network. Finally, the cloud gaming client decodes and outputs the game screen.

The inventor of the present disclosure found during the actual research and development process that, based on the existing detection signal feedback mode, although the player is able to directly find the target object according to the detection signal, due to the overly direct nature of this detection signal feedback mode, the active search for objects is turned into a passive search for objects, thus reducing the sense of immersion during the process of searching for objects in the game. From the above, it can be seen that the detection signal feedback mode in the related art is too direct, which results in the active search for objects being turned into a passive search for objects, thereby reducing the sense of immersion in the process of searching for objects in the game. The embodiments of the present disclosure provide a game signal feedback method and apparatus, an electronic device and a computer-readable storage medium, which can improve the accuracy of game signal feedback and avoid the problem that the prompt for searching for objects is too direct due to the detection tool directly feeding back the precise location information of the target object to the player after performing detection.

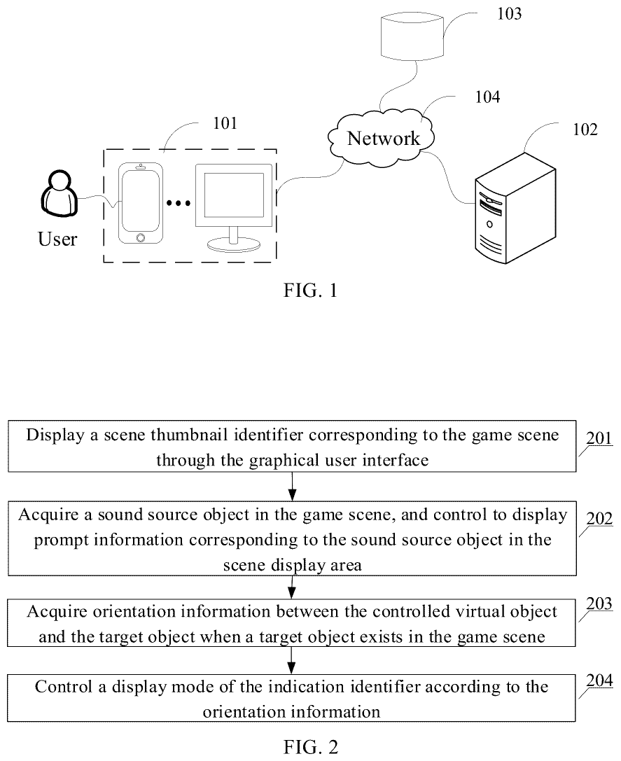

Reference is made to FIG. 1, which is a schematic diagram of a game signal feedback system provided by an embodiment of the present disclosure. The system may include at least one terminal 101, at least one server 102, at least one database 103, and a network 104. The terminal 101 held by the user may be connected to the servers of different games through the network 104. The terminal 101 is any device with computing hardware capable of supporting and executing software products corresponding to the game. In addition, the terminal 101 is equipped with one or more multi-touch sensitive screens for sensing and obtaining the user inputs through touch or sliding operations performed at multiple points on one or more touch display screens. In addition, when the system includes a plurality of terminals 101, a plurality of servers 102, and a plurality of networks 104, different terminals 101 may be connected to each other through different networks 104 and different servers 102. The network 104 may be a wireless network or a wired network. Examples of wireless networks include a wireless local area network (WLAN), a local area network (LAN), a cellular network, a 2G network, a 3G network, a 4G network, a 5G network, etc. In addition, different terminals 101 may also use their own Bluetooth networks or hotspot networks to connect to other terminals or to servers, etc. For example, multiple users may be online through different terminals 101 and thus being connected and synchronized with each other through a suitable network to support multi-player games. In addition, the system may include multiple databases 103, which are coupled to different servers 102, and information related to the game environment may be continuously stored in the databases 103 when different users are online for multi-player games.

The game signal feedback method provided in the embodiments of the present disclosure may be executed by a terminal or a server. The embodiments of the present disclosure are described by taking the game signal feedback method being executed by a terminal as an example. The terminal includes a touch display screen and a processor, and the touch display screen is used for presenting the graphical user interface and receiving operation instructions generated by the user acting on the graphical user interface. When the user operates the graphical user interface through the touch display screen, the graphical user interface may control the local content of the terminal by responding to the received operation instruction, and can also control the content of the opposite server by responding to the received operation instructions. For example, the operation instructions generated by the user acting on the graphical user interface include an instruction for launching a game application program, and the processor is configured to launch the game application program after receiving the instruction to launch the game application program provided by the user. In addition, the processor is configured to render and draw a graphical user interface associated with the game on the touch display screen. The touch display screen is a multi-touch sensitive screen that is capable of sensing touch or sliding operations performed simultaneously at multiple points on the screen. The user performs touch operations on the graphical user interface with fingers, and when the graphical user interface detects the touch operation, different virtual objects in the graphical user interface of the game are controlled to perform actions corresponding to the touch operation. For example, the game may be any of the casual game, action game, role-playing game, strategy game, sports game, puzzle game, etc. The game may include a virtual scene of the game drawn on the graphical user interface. In addition, the virtual scene of the game may include one or more virtual objects controlled by the user (or player), such as a virtual character. In some embodiments, the virtual scene of the game further includes one or more elements, such as skills, scores, character health status, energy, etc., to provide help to the player, provide virtual services, increase the scores related to the player's performance, etc. In addition, the graphical user interface may also present one or more indicators to provide indication information to the player. For example, the game may include a virtual object controlled by the player and one or more other virtual objects (such as enemy characters). In one embodiment, one or more other virtual objects are controlled by other players of the game. For example, one or more other virtual objects may be controlled by a computer, such as a robot using an artificial intelligence (AI) algorithm, to achieve a human-machine battle mode. For example, the virtual object has various skills or abilities that a game player uses to achieve objects. For example, the virtual object has one or more weapons, props, tools, etc. that may be used to eliminate other objects in the game. Such skills or abilities may be activated by a game player using one of a plurality of preset touch operations on the touch display screen of the terminal. The processor may be configured to present corresponding game screens in response to operation instructions generated by the touch operations of the user.

The methods for game signal feedback in the embodiments of the present disclosure will be introduced below. In these embodiments, the terminal device running the current game is used as the execution subject of the game signal feedback method. For the sake of simplified description, this execution subject will be omitted in the following text. It should be noted that the description order in the following embodiments is not used as a limitation on the preferred order of the embodiments. Although the logical order is shown in the flow charts, in some cases, the steps shown or described may be performed in an order different from that shown in the accompanying drawings. The game signal feedback method may display a graphical user interface through a terminal device, and the graphical user interface includes a game scene and a controlled virtual object located in the game scene, and the controlled virtual object corresponds to the terminal device.

As shown in FIG. 2, the specific process of the game signal feedback method may include steps 201 to 204.

In step 201, a scene thumbnail identifier corresponding to the game scene is displayed through the graphical user interface.

The scene thumbnail includes a scene display area and an indication identifier, the scene display area displays a character identifier corresponding to the controlled virtual object, and the indication identifier is located at an edge of the scene display area.

The scene thumbnail identifier is a thumbnail identifier of the game scene. For example, it may specifically be a mini-map of the game.

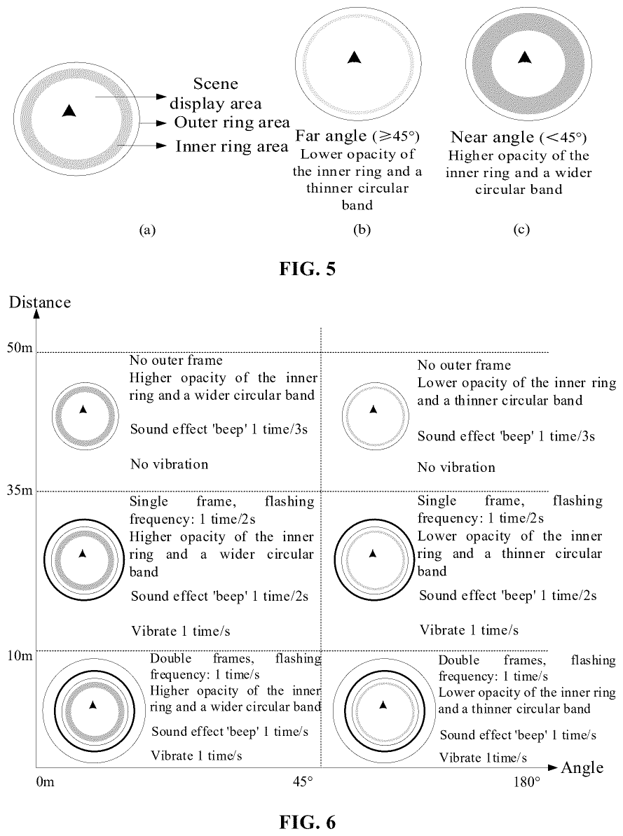

The scene display area is a region for displaying a thumbnail of the game scene. For example, as shown in (a) in FIG. 4 or (a) in FIG. 5, the scene display area may specifically be a main area of a game mini-map.

The indication identifier is an identifier used to feedback detection information of the detection tool used by the controlled virtual object. For example, as shown in (a) in FIG. 4 or (a) in FIG. 5, the indication identifier may be an identifier presented in the edge area of the game mini-map (such as a radar displayed in the edge area of the game mini-map).

The detection tool is a tool that may be used to detect target objects, such as a virtual radar, virtual compass, virtual sonar, virtual radio, etc. in the game.

The controlled virtual object refers to an object using a detection tool to detect target objects, which may specifically be a virtual character, virtual animal, etc., operated by the player in the current game.

The target object refers to the object to be searched for, such as virtual props, virtual animals, virtual characters, etc. in the game.

The current game is a game in which detection tools may be used to detect target objects, for example, a game in which a radar may be used to hunt for treasures.

In step 202, a sound source object in the game scene is acquired, and prompt information corresponding to the sound source object is controlled to be displayed in the scene display area.

The sound source object is the sound emitted in the game scene, for example, the sound of gunfire, footsteps or other sounds around the controlled virtual object.

The prompt information corresponding to the sound source object may specifically be a special effect corresponding to the sound source object.

For example, taking the sound source object being the sound of gunfire around the controlled virtual object as an example, when a virtual interactive object in the game scene fires the gun around the controlled virtual object, the special effect of the sound of gunfire around the controlled virtual object is presented in the scene display area.

In step 203, when a target object exists in the game scene, orientation information between the controlled virtual object and the target object is acquired.

In step 203, the target object is at least one of the following virtual objects: a virtual item and a virtual interactive object located in the game scene, where the virtual item may be a treasure box, etc., and the virtual interactive object may be the enemy of the controlled virtual object, etc.

The virtual interactive object is configured to provide game information in response to an interactive behavior of the controlled virtual object

The orientation information is information used for indicating the relative spatial position relationship between the controlled virtual object and the target object. For example, the orientation information may be a target distance between the controlled virtual object and the target object, or a target angle between the controlled virtual object and the target object.

Depending on different triggering conditions for acquiring the orientation information, the orientation information in step 203 may be acquired in various ways, which includes, for example, the following.
1) When the detection tool turns on the detection function (such as releasing a first skill) and there is a target object in the game scene, the orientation information is acquired. In this case, step 203 may specifically include: in response to the release instruction for the first skill, when there is a target object corresponding to the first skill in the game scene, acquiring the orientation information between the controlled virtual object and the target object. The first skill is a skill for detecting a target object, such as a radar skill, a compass skill, etc. For example, the graphical user interface may also be provided with a skill control (such as a skill control for detecting a target object, that is, a control corresponding to the first skill), and the first skill may be released via a touch operation on the skill control. For example, taking the detection tool as a radar (i.e., the first skill is a radar skill) as an example, when the player performs a touch operation on the radar control, the release instruction of the radar skill may be triggered. At this time, if there is a target object in the game scene, the orientation information between the controlled virtual object and the target object will be acquired.

The target object corresponding to the first skill refers to the target object that can be detected by the first skill. For example, the current game is provided with multiple skills that are capable of detecting target objects, such as a radar skill and a compass skill. Assuming that the target object that can be detected by the radar skill is object A, and the target object that can be detected by the compass skill is object B; if the triggered first skill is the radar skill, then the target object corresponding to the first skill is object A; if the triggered first skill is the compass skill, then the target object corresponding to the first skill is object B.
2) When the detection tool turns on the detection function (such as releasing the first skill), the target object exists in the game scene, and the current moment is within the effective period of the first skill, the orientation information is acquired. In this case, the step 203 specifically includes: in response to the release instruction for the first skill, detecting whether the target object corresponding to the first skill exists in the game scene during an effective period of the first skill; when there is a target object corresponding to the first skill in the game scene, acquiring the orientation information between the controlled virtual object and the target object. When there is no target object corresponding to the first skill in the game scene, no further processing is performed.

Therefore, by setting the effective period for the first skill, the orientation information between the controlled virtual object and the target object can be acquired within the effective period after the first skill is released, and the orientation information between the controlled virtual object and the target object will no longer be acquired after the effective period after the first skill is released. On the one hand, the feedback timing of the detection feedback signal of the target object can be more closely aligned with the effective period of the first skill in the actual game scene, and on the other hand, it can avoid continuously acquiring the orientation information, thereby reducing the data processing amount for acquiring the orientation information.

Depending on the specific presentation forms of the orientation information, there are various ways to acquire the orientation information in the step 203, which include, for example, the following ways (1) to (3).
(1) The orientation information includes the target distance. That is, the detection signal that the detection tool needs to feedback is the target distance between the controlled virtual object and the target object. In this case, in the step 203, when it is detected that the target object exists in the game scene, the target distance between the controlled virtual object and the target object may be acquired as the orientation information.

The target distance may be a straight-line distance between the controlled virtual object and the target object, a path distance required from the current position of the controlled virtual object to the position of the target object, or the like.

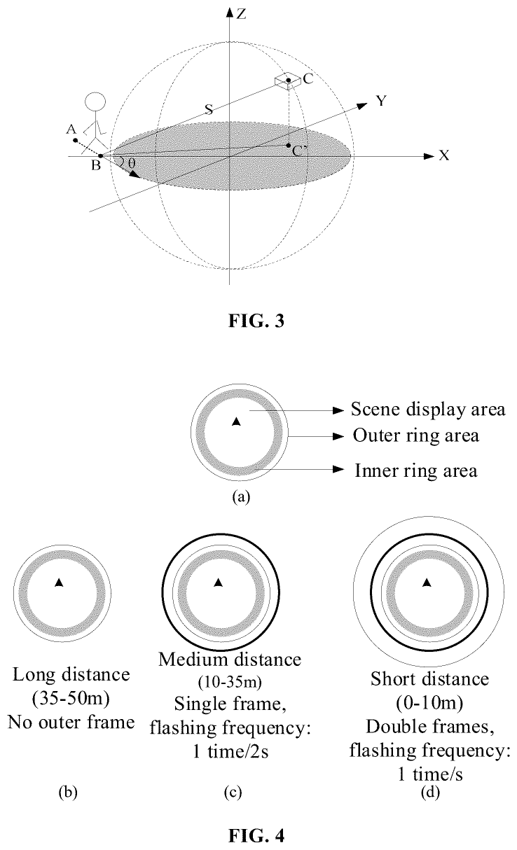

Taking the target distance as the straight-line distance between the controlled virtual object and the target object as an example, as shown in FIG. 3, the controlled virtual object is at the position of point B and the target object is at the position of point C. First, based on the scene space coordinate system of the current game, the current position of the controlled virtual object (i.e., the coordinate position of point B) and the position of the target object (i.e., the coordinate position of point C) are acquired. Then, the straight-line distance between the controlled virtual object and the target object (i.e., a straight-line distance S between point B and point C) is calculated based on the current position of the controlled virtual object (i.e., the coordinate position of point B) and the position of the target object (i.e., the coordinate position of point C) as the target distance between the controlled virtual object and the target object.

Furthermore, the target distance may be represented by a specific distance value (for example, the target distance may be 1 meter, 2 meters, etc.). Alternatively, the target distance may also be represented by a corresponding distance interval. For example, the target distance between the controlled virtual object and the target object in the current game may be determined according to the preset distance value interval into which the actual distance value between the controlled virtual object and the target object falls. For example, as shown in Table 1, assuming that the detection range of the detection tool (such as radar) is 50 meters, the distance change may be divided into three prompt levels: short distance (the corresponding preset distance value interval is 0-10 meters), medium distance (the corresponding preset distance value interval is 10-35 meters) and long distance (the corresponding preset distance value interval is 35-50 meters). In this case, when the actual value of the distance between the controlled virtual object and the target object is “5 meters”, it may be determined that the target distance between the controlled virtual object and the target object in the current game is “short distance”; when the actual value of the distance between the controlled virtual object and the target object is “20 meters”, it may be determined that the target distance between the controlled virtual object and the target object in the current game is “medium distance”; when the actual value of the distance between the controlled virtual object and the target object is “40 meters”, it may be determined that the target distance between the controlled virtual object and the target object in the current game is “long distance”. Here, value intervals of the preset distance are only examples and shall not be limited thereto.

TABLE 1

| Preset distance value | Target | Prompt intensity for |
|---|---|---|
| interval s (unit: meter) | distance | the distance |
| 0 ≤ s < 10 | Short distance | Level 3 |
| 10 ≤ s < 35 | Medium distance | Level 2 |
| 35 ≤ s < 50 | Long distance | Level 1 |

(2) The orientation information includes the target angle. That is, the detection signal that the detection tool needs to feedback is the target angle between the controlled virtual object and the target object. In this case, in step 203, when it is detected that the target object exists in the game scene, the target angle between the controlled virtual object and the target object may be acquired as the orientation information.

The target angle may be an angle formed by a first ray and a second ray. As shown in FIG. 3, the first ray (the ray B of which extension line passes through point A as shown in FIG. 3) is a ray with the current position of the controlled virtual object as the starting point and pointing in the forward direction of the controlled virtual object, and the second ray (the ray BC′ as shown in FIG. 3) is a ray with the current position of the controlled virtual object as the starting point and pointing to the projection point of the target object on the horizontal plane where the controlled virtual object is located. It should also be noted that the angle described in this embodiment takes an angle ≤180° as an example.

As shown in FIG. 3, the forward direction of the controlled virtual object may be determined based on the connection line between the current position of the controlled virtual object (as shown by point B in FIG. 3) and the previous position of the controlled virtual object (as shown by point A in FIG. 3). Specifically, the direction from the previous position of the controlled virtual object to the current position of the controlled virtual object may be taken as the forward direction of the controlled virtual object.

The previous position of the controlled virtual object may be determined through various manners, which includes, for example, the following.

\textcircled{1} The previous position may be the position of the controlled virtual object in the previous second, previous minute, etc., before it enters the current position. For example, the controlled virtual object is at position 1 in the 1st second and at position 2 in the 2nd second. Assuming that the current position of the controlled virtual object is position 2, then the previous position of the controlled virtual object is position 1.

\textcircled{2} The previous position may also be the passed position with the shortest time interval between the passed time and the current time among various passed positions traversed by the controlled virtual object within a preset duration before entering its current position. For example, the controlled virtual object passed through position 3, position 4, and position 5 in sequence in the first 3 seconds, and the controlled virtual object is at position 6 in the 4th second. Assuming that the current position of the controlled virtual object is position 6, the previous position of the controlled virtual object is position 5.

The ways for determining the previous position herein are merely examples. The way for determining the previous position may be set according to the requirements of the actual service scenario and is not limited thereto.

As shown in FIG. 3, a horizontal plane where the controlled virtual object is located may be a plane that is based on the scene space coordinate system of the current game, with a height value equal to the Z-axis coordinate value of the current position of the controlled virtual object, and parallel to the X-axis and the Y-axis. Alternatively, the horizontal plane where the controlled virtual object is located may also be a plane that is based on scene space coordinate system of the current game, with a height value equal to the X-axis coordinate value of the current position of the controlled virtual object, and parallel to the Z-axis and the Y-axis. Alternatively, the horizontal plane where the controlled virtual object is located may also be a plane that is based on the scene space coordinate system of the current game, with a height value equal to the Y-axis coordinate value of the current position of the controlled virtual object, and parallel to the X-axis and the Z-axis.

For example, as shown in FIG. 3, taking the horizontal plane where the controlled virtual object is located as the plane parallel to the X-axis and Y-axis of the scene space coordinate system as an example, first, based on the scene space coordinate system of the current game, the previous position of the controlled virtual object (i.e., the coordinate position of point A), the current position of the controlled virtual object (i.e., the coordinate position of point B), and the position of the target object (i.e., the coordinate position of point C) are acquired. Then, based on the position of the target object (i.e., the coordinate position of point C) and the current position of the controlled virtual object (i.e., the coordinate position of point B), the position of the projection point of the target object on the horizontal plane where the controlled virtual object is located is acquired (i.e., the coordinate position of point C′). Next, according to the previous position of the controlled virtual object (i.e., the coordinate position of point A) and the current position of the controlled virtual object (i.e., the coordinate position of point B), the first ray (the ray B of which extension line passes through point A as shown in FIG. 3) with the current position of the controlled virtual object as the starting point and pointing in the forward direction of the controlled virtual object is determined. Then, according to the current position of the controlled virtual object (i.e., the coordinate position of point B) and the position of the projection point (i.e., the coordinate position of point C′), the second ray (the ray BC′ as shown in FIG. 3) with the current position of the controlled virtual object as the starting point and pointing to the projection point of the target object on the horizontal plane where the controlled virtual object is located is determined. Finally, the angle between the first ray and the second ray (i.e., the angle θ in FIG. 3) is calculated as the target angle between the controlled virtual object and the target object.

Furthermore, in order to avoid frequent changes in the target angle between the controlled virtual object and the target object due to the adjustment of the controlled virtual object's orientation (i.e., the forward direction of the controlled virtual object), thereby avoiding the problem that the detection signal cannot be accurately fed back to the user due to too frequent angle switching, the target angle between the controlled virtual object and the target object may also be determined with reference to the distance that the controlled virtual object has continuously moved along the target angle, or time for which the controlled virtual object has continuously moved along the target angle. In this case, the step 203 may specifically include: when the target object exists in the game scene, acquiring the current angle between the controlled virtual object and the target object (the method for acquiring the current angle may refer to the relevant description of the target angle in the previous text); acquiring the distance that the controlled virtual object has continuously moved along the current angle (e.g., 1 meter); if the distance of the continuous movement is greater than or equal to a preset movement distance threshold (e.g., 0.1 meters), using the current angle as the target angle between the controlled virtual object and the target object. If the distance of the continuous movement (e.g., 0.05 meters) is less than the preset movement distance threshold (e.g., 0.1 meters), no further processing is performed, or the distance that the controlled virtual object has continuously moved along the current angle is re-acquired to determine whether the distance of the continuous movement is greater than or equal to the preset movement distance threshold. The distance of the continuous movement is the distance that the controlled virtual object has moved from other positions continuously towards the current angle to the current position.

Alternatively, the step 203 may specifically include: when the target object exits in the game scene, acquiring the current angle between the controlled virtual object and the target object; acquiring a continuous movement duration of the controlled virtual object along the current angle; if the continuous movement duration (e.g., 1 second) is greater than or equal to a preset movement duration threshold (e.g., 0.5 seconds), using the current angle as the target angle between the controlled virtual object and the target object. If the continuous movement duration (e.g., 0.02 seconds) is less than the preset movement duration threshold (e.g., 0.5 seconds), no further processing is performed, or the continuous movement duration of the controlled virtual object along the current angle is re-acquired to determine whether the continuous movement duration is greater than or equal to the preset movement duration threshold. The continuous movement duration is the duration for which the controlled virtual object has moved from other positions continuously towards the target angle to the current position.

The specific value of the preset movement distance threshold and the specific value of the preset movement duration threshold may be set according to requirements of actual service scenario and are not limited thereto.

Further, the target angle may be represented by a specific angle value (for example, the target angle may be 30°, 60° . . . ). Alternatively, the target angle may also be represented by a corresponding angle interval. For example, the target angle between the controlled virtual object and the target object in the current game may be determined according to a preset angle value interval into which the actual angle value between the controlled virtual object and the target object falls. For example, as shown in Table 2, the angle changes may be divided into two prompt levels: a near angle (the corresponding preset angle value interval is ≤45°) and a far angle (the corresponding preset angle value interval is >45°). In this case, when the actual angle value between the controlled virtual object and the target object is 20°, it may be determined that the target angle between the controlled virtual object and the target object in the current game is a “near angle”; when the actual angle value between the controlled virtual object and the target object is 60°, it may be determined that the target angle between the controlled virtual object and the target object in the current game is a “far angle”. Here, the preset angle value intervals are only examples and are not limited thereto.

TABLE 2

| | | Prompt intensity |
|---|---|---|
| Preset angle value interval θ | Target angle | for the angle |
| 0 ≤ 45° | Near angle | Level 2 |
| 0 > 45° | Far angle | Level 1 |

(3) The orientation information includes the target distance and the target angle. That is, the detection signal that the detection tool needs to feedback is the target distance and the target angle between the controlled virtual object and the target object. In this case, in the step 203, when the target object is detected in the game scene, the target distance between the controlled virtual object and the target object, and the target angle between the controlled virtual object and the target object may be acquired as the orientation information.

In step 204, a display mode of the indication identifier is controlled according to the orientation information.

The “controlling the display mode of the indication identifier” in the step 204 may be implemented in various ways, which includes, for example, the following.
(I) The orientation information includes the target distance. That is, when the detection signal that the detection tool needs to feedback is the distance between the controlled virtual object and the target object, step 204 may include the following step 2041A.

In step 2041A, a first visual signal associated with a prompt intensity into which the target distance falls is controlled to be displayed in a first prompt area of the indication identifier.

The first prompt area refers to an area of the indication identifier included in the scene thumbnail identifier, which is used to feedback the target distance between the controlled virtual object and the target object. In some embodiments, when the indication identifier is only used to feedback the detection signal of “the target distance between the controlled virtual object and the target object”, the first prompt area may be the entire area of the indication identifier (such as the edge of the scene display area). In some other embodiments, for example, when the indication identifier is used to feedback two or more detection signals such as “the target distance between the controlled virtual object and the target object” and “the target angle between the controlled virtual object and the target object”, the first prompt area may be a partial area of the indication identifier (such as the outer ring area of the edge of the scene display area, the inner ring area of the edge of the scene display area, etc.).

The visual signal refers to a signal that can be perceived through vision, such as a graphic jitter effect.

The first visual signal is a visual signal used to feedback the target distance between the controlled virtual object and the target object.

For example, in the step 2041A, a target distance prompt intensity into which the target distance falls is first determined from preset distance prompt intensities; and then a first visual signal associated with the prompt intensity into which the target distance falls is displayed in the first prompt area of the indication identifier.

The preset distance prompt intensities include a plurality of levels, and the distance prompt intensities with different levels are used to reflect different target distances (between the controlled virtual object and the target object). Each preset distance prompt intensity has a target distance mapped thereto.

The prompt intensity into which the target distance falls (referred to as “target distance prompt intensity”) refers to the preset distance prompt intensity corresponding to the target distance among multiple preset distance prompt intensities, and the target distance prompt intensity is used to reflect the degree of distance proximity between the controlled virtual object and the target object. The target distance is negatively correlated with the target distance prompt intensity, that is, a higher target distance prompt intensity indicates a closer target distance between the controlled virtual object and the target object; conversely, a lower target distance prompt intensity indicates a farther target distance between the controlled virtual object and the target object.

For example, the distance prompt intensity mapped to the target distance determined in step 203 may be determined according to a first mapping relationship between the target distance and the distance prompt intensity, which serves as the target distance prompt intensity into which the target distance falls determined in step 204. For example, as shown in Table 1, the preset distance prompt intensities are divided into three levels: “level 3”, “level 2”, and “level 1” (where, the larger the level number, the higher the distance prompt intensity; conversely, the smaller the level number, the lower the distance prompt intensity). If the target distance between the controlled virtual object and the target object is determined to be “short distance” in step 203, the target distance prompt intensity within which the target distance between the controlled virtual object and the target object falls may be determined to be “Level 3” in step 204.

For example, as shown in FIG. 4, (a) in FIG. 4 is a scene thumbnail identifier corresponding to the game scene displayed through the graphical user interface, the main part of which is the scene display area, the edge of which is the indication identifier, and the indication identifier part includes an outer ring area and an inner ring area. Taking the indication identifier being a radar, the first prompt area being the outer ring area of the radar, and the first visual signal being the number of outer frames and the flashing frequency of the outer frames of the outer ring as an example, the number of outer frames and the flashing frequency of the outer frames of the outer ring of the target distance prompt intensity may be output through the outer ring area of the radar displayed at the edge of the scene thumbnail identifier. With reference to FIG. 4 and FIG. 6, as shown in Table 1, it is assumed that the preset distance prompt intensities include “level 3”, “level 2”, and “level 1”, which are respectively mapped to the target distances of “short distance”, “medium distance”, and “long distance”. The visual representations corresponding to the distance prompt intensities in “level 3”, “level 2”, and “level 1” are respectively as follows: “double frames, flashing frequency: 1 time/s” (as shown in (d) of FIG. 4), “single frame, flashing frequency: 1 time/2 s” (as shown in (c) of FIG. 4), and “no outer frame” (as shown in (b) of FIG. 4).

If it is determined in the step 203 that the target distance is “short distance”, then in step 204, the target distance prompt intensity is the distance prompt intensity “level 3” that is mapped to “short distance”. In the step 204, the outer ring area of the radar displayed at the edge of the scene thumbnail identifier is controlled to be displayed according to the visual representation corresponding to the target distance prompt intensity “level 3”, i.e., “double frames, flashing frequency: 1 time/s”, as shown in (d) in FIG. 4, so as to output the first visual signal of the target distance prompt intensity through the outer ring area of the radar displayed at the edge of the scene thumbnail identifier.

If it is determined in step 203 that the target distance is “medium distance”, then in step 204, the target distance prompt intensity is the distance prompt intensity “level 2” that is mapped to “medium distance”. In step 204, the outer ring area of the radar displayed at the edge of the scene thumbnail identifier is controlled to be displayed according to the visual representation corresponding to the target distance prompt intensity “level 2”, i.e., “single frame, flashing frequency: 1 time/2 s”, as shown in (c) in FIG. 4, so as to output the first visual signal of the target distance prompt intensity through the outer ring area of the radar displayed at the edge of the scene thumbnail identifier.

If it is determined in the step 203 that the target distance is “long distance”, then in the step 204, the target distance prompt intensity is the distance prompt intensity “level 1” that is mapped to “long distance”. In the step 204, the outer ring area of the radar displayed at the edge of the scene thumbnail identifier is controlled to be displayed according to the visual representation corresponding to the target distance prompt intensity “level 1”, i.e., “no outer frame”, as shown in (b) in FIG. 4, so as to output the first visual signal of the target distance prompt intensity through the outer ring area of the radar displayed at the edge of the scene thumbnail identifier.

In this way, the player can perceive the target distance between the controlled virtual object and the target object according to the change of the first visual signal generated by the outer ring area of the radar.

It can be seen that, by controlling the first visual signal associated with the prompt intensity into which the target distance falls displayed in the first prompt area of the indication identifier, since the first visual signal will produce changes in distance prompt intensity according to the degree of distance proximity between the controlled virtual object and the target object, the player can perceive the distance between the controlled virtual object and the target object according to the change in the first visual signal generated in the first prompt area. It realizes feeding back the detection signal of the detection tool by using the change in the prompt intensity of the first visual signal, thereby avoiding the problem that the detection tool directly feeds back the precise location information of the target object after detection, which results in the search prompt being too direct, and further avoiding the problem that active exploration and search becomes passive search, thereby improving the interactive richness of the game.
(II) The orientation information includes the target angle. That is, when the detection signal that the detection tool needs to feedback is the angle between the controlled virtual object and the target object, step 204 may include the following step 2041B.

In the step 2041B, a second visual signal associated with a prompt intensity within which the target angle falls is controlled to be displayed in a second prompt area of the indication identifier.

The second prompt area refers to an area of the indication identifier included in the scene thumbnail identifier, which is used to feedback the target angle between the controlled virtual object and the target object. In some embodiments, for example, when the indication identifier is only used to feedback the detection signal of “the target angle between the controlled virtual object and the target object”, the second prompt area may be the entire area of the indication identifier (such as the edge of the scene display area). In other embodiments, for example, when the indication identifier is used to feedback two or more detection signals such as “the target angle between the controlled virtual object and the target object” and “the target distance between the controlled virtual object and the target object”, the second prompt area may be a partial area (such as the outer ring area of the edge of the scene display area, the inner ring area of the edge of the scene display area, etc.) of the indication identifier (such as the edge of the scene display area).

The second visual signal is a visual signal used to feed back the target angle between the controlled virtual object and the target object.

For example, in the step 2041B, a target angle prompt intensity within which the target angle falls is first determined from preset angle prompt intensities.

The preset angle prompt intensities include a plurality of levels, and the angle prompt intensities with different levels are used to reflect different target angles (between the controlled virtual object and the target object). Each preset angle prompt intensity has a target angle mapped thereto.

The prompt intensity within which the target angle falls (referred to as “target angle prompt intensity”) refers to the preset angle prompt intensity corresponding to the target angle among multiple preset angle prompt intensities, and the target angle prompt intensity is used to reflect the degree of angular proximity between the controlled virtual object and the target object. The target angle is negatively correlated with the target angle prompt intensity, that is, a higher target angle prompt intensity indicates a smaller target angle between the controlled virtual object and the target object; conversely, a lower target angle prompt intensity indicates a larger target angle between the controlled virtual object and the target object.

For example, the angle prompt intensity mapped to the target angle determined in the step 203 may be determined according to a second mapping relationship between the target angle and the angle prompt intensity, which serves as the target angle prompt intensity into which the target angle falls determined in the step 204. For example, as shown in Table 2, the preset angle prompt intensities are divided into two levels: “level 2” and “level 1” (where the larger the level number, the higher the angle prompt intensity; conversely, the smaller the level number, the lower the angle prompt intensity). If the target angle between the controlled virtual object and the target object is determined to be a “near angle” in the step 203, the target angle prompt intensity within which the target angle between the controlled virtual object and the target object falls may be determined to be “level 2” in the step 204.

For example, as shown in FIG. 5, (a) in FIG. 5 is a scene thumbnail identifier corresponding to the game scene displayed through the graphical user interface, the main part of which is the scene display area, the edge of the scene display area is the indication identifier, and the indication identifier part includes an outer ring area and an inner ring area. Taking the indication identifier being a radar, the second prompt area being the inner ring area of the radar, and the second visual signal being the opacity and ring width of the inner ring area as an example, the opacity and ring width of the inner ring area of the target angle prompt intensity may be output through the inner ring area of the radar displayed at the edge of the scene thumbnail identifier. As shown in Table 2, it is assumed that the preset angle prompt intensities include angle prompt intensities in “level 2” and “level 1”, which have a mapping relationship with the target angle “near angle” and “far angle” respectively. The visual representations corresponding to the angle prompt intensities in “level 2” and “level 1” are respectively as follows: “higher opacity of the inner ring and a wider circular band” (as shown in (c) of FIG. 5) and “lower opacity of the inner ring and a thinner circular band” (as shown in (b) of FIG. 5). Here, higher opacity means higher color saturation.

If it is determined in the step 203 that the target angle is a “near angle”, then in step 204, the target angle prompt intensity is the angle prompt intensity “level 2” that is mapped to the “near angle”. In step 204, the inner ring area of the radar displayed at the edge of the scene thumbnail identifier is controlled to be displayed according to the visual representation corresponding to the target angle prompt intensity “level 2”, i.e., “the inner ring has a higher opacity and a wider ring”, so as to output the second visual signal of the target angle prompt intensity through the inner ring area of the radar displayed at the edge of the scene thumbnail identifier.

If it is determined in the step 203 that the target angle is a “far angle”, then in the step 204, the target angle prompt intensity is an angle prompt intensity “level 1” that is mapped to the “far angle”. In the step 204, the inner ring area of the radar displayed at the edge of the scene thumbnail identifier is controlled to be displayed according to the visual representation corresponding to the target angle prompt intensity “level 1”, i.e., “the inner ring has a lower opacity and a thinner ring”, so as to output the second visual signal of the target angle prompt intensity through the inner ring area of the radar displayed at the edge of the scene thumbnail identifier.

In this way, the player can perceive the target angle between the controlled virtual object and the target object according to the change of the second visual signal generated by the inner ring area of the radar.

It can be seen that, by controlling the second visual signal associated with the prompt intensity within which the target angle falls displayed in the second prompt area of the indicator identifier, since the second visual signal will produce changes in the angle prompt intensity according to the degree of angular proximity between the controlled virtual object and the target object, the player can perceive the angle between the controlled virtual object and the target object according to the change in the second visual signal generated in the second prompt area. It realizes feeding back the detection signal of the detection tool by using the change in the prompt intensity of the second visual signal, thereby avoiding the problem that the detection tool directly feeds back the precise location information of the target object after detection, which results in the search prompt being too direct, and further avoiding the problem that active exploration and search becomes passive search, thereby improving the interactive richness of the game.

It can be seen that, by determining the target distance prompt intensity within which the target distance between the controlled virtual object and the target falls, and the target angle prompt intensity within which the target angle falls, from various preset prompt intensities of the detection tool currently used by the controlled virtual object, the first visual signal of the target distance prompt intensity and a second visual signal of the target angle prompt intensity are output through the indication identifier. Since the target distance prompt intensity is positively correlated with the degree of distance proximity (between the controlled virtual object and the target), and the target angle prompt intensity is positively correlated with the degree of angular proximity (between the controlled virtual object and the target), the target visual signals will exhibit visual signals of different intensities as the distance and angular proximity between the controlled virtual object and the target object change. It can provide the player with feedback on the position information of the target object without directly feedback on the position information of the target object, thereby ensuring that the player can use the detection signal to accurately and gradually find the target object. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game.
(III) The orientation information includes the target distance and the target angle. That is, when the detection signal that the detection tool needs to feedback is the distance between the controlled virtual object and the target object, and the angle between the controlled virtual object and the target object, step 204 may include the following steps 2041C to 2042C.

In the step 2041C, a first visual signal associated with the prompt intensity into which the target distance falls is controlled to be displayed in a first prompt area of the indication identifier.

In the step 2042C, a second visual signal associated with the prompt intensity into which the target angle falls is controlled to be displayed in a second prompt area of the indication identifier.

The specific implementations of the steps 2041C to 2042C are similar to those of the steps 2041A and 2041B described above. For details, reference may be made to relevant descriptions in the previous text and will not be repeated herein.

In the first aspect, the detection signal of the detection tool is fed back through the scene thumbnail identifier (such as the mini-map) corresponding to the game scene displayed on the graphical user interface. On the one hand, it saves screen space and simplifies the game interface, especially for the game interface of mobile games, thereby improving the simplicity of the game interface, and further enhancing the convenience of game interaction operations on the basis of providing the player with the detection signals of the detection tool. On the other hand, since the mini-map is a permanent information panel on the main interface and is an important tool to assist the player in game exploration, feeding back the detection signals of the detection tool through the mini-map makes the object-searching prompt more in line with the player's cognition, thereby reducing the player's game learning cost and enabling the player to quickly understand the presentation manner of the detection signal. Furthermore, it allows players to search for the target object while performing other game operations.

In the second aspect, the first visual signal of the target distance prompt intensity is output through the first prompt area of the indication identifier; the second visual signal of the target angle prompt intensity is output through the second prompt area of the indication identifier. On the one hand, the player can perceive the distance between the controlled virtual object and the target object, on the other hand, the player can perceive the angle between the controlled virtual object and the target object, so that the forward direction of the controlled virtual object can be continuously promoted toward the target object according to the detection signal. The distance and angle between the controlled virtual object and the target object can be fed back together to improve the comprehensiveness of the feedback of the detection signal. It avoids outputting only the first visual signal of the target distance prompt intensity or only the second visual signal of the target angle prompt intensity, which would cause the player to only perceive the target distance between the controlled virtual object and the target object or only perceive the target angle between the controlled virtual object and the target object, thereby avoiding the problem that the detection signal cannot provide the player with the accurate position of the target object.

Furthermore, to prevent players from relying solely on a certain type of sensory information prompt (such as visual signals) to perceive detection signals during object-searching process, in addition to the visual signals, auditory and tactile signals may also be used to feedback the detection signals acquired from the detection performed by the detection tool, which ensures that the player can timely perceive the detection signals acquired from the detection performed by the detection tool under different usage conditions, and avoid the problem that the player ignores the visual signal and fails to perceive the detection signal in time and accurately. In this case, the game signal feedback method may further include the following steps A1~A2.

In the step A1, an auditory signal of the target prompt intensity is output.

The auditory signal refers to a signal that can be perceived by hearing, such as a sound effect.

In some embodiments, the target prompt intensity is a target distance prompt intensity, and an auditory signal of the prompt intensity into which the target distance falls (i.e., the target distance prompt intensity) may be output so that the player can perceive the distance between the controlled virtual object and the target object detected by the detection tool through auditory information.

For example, as shown in Table 1, it is assumed that the preset distance prompt intensities include distance prompt intensities “level 3”, “level 2”, and “level 1” which are mapped to the target distances “short distance”, “medium distance”, and “long distance”, respectively. As shown in FIG. 6, the auditory representations corresponding to the distance prompt intensities “level 3”, “level 2”, and “level 1” are respectively as follows: “sound effect ‘beep’ 1 time/s”, “sound effect ‘beep’ 1 time/2 s”, and “sound effect ‘beep’ 1 time/3 s”. If the target distance is determined to be “short distance” in the step 203, the target distance prompt intensity in the step 204 is the distance prompt intensity “level 3” which is mapped to “short distance”. In the step A1, the auditory representation “sound effect ‘beep’ once per second” corresponding to the target distance prompt intensity “level 3” may be output by the terminal device running the current game.

In some embodiments, the target prompt intensity is a target angle prompt intensity, and an auditory signal of the prompt intensity within which the target angle falls (i.e., the target angle prompt intensity) may be output so that the player can perceive the angle between the controlled virtual object and the target object detected by the detection tool through auditory information.

For example, as shown in the Table 2, it is assumed that the preset angle prompt intensities include angle prompt intensities “level 2” and “level 1” which are respectively mapped to the target angles “near angle” and “far angle”. The auditory representations corresponding to the angle prompt intensities “level 2” and “level 1” are respectively as follows: “sound effect ‘beep’ 1 time/s” and “sound effect ‘beep’ 1 time/2 s”. If the target angle is determined to be “far angle” in the step 203, the target distance prompt intensity in the step 204 is the angle prompt intensity “level 1” which is mapped to the “far angle”. In the step A1, the auditory representation “sound effect ‘beep’ once per second” corresponding to the target angle prompt intensity “level 1” may be output by the terminal device running the current game.

Furthermore, in order to prevent the auditory signal from interfering with other non-exploration operations (such as opening the equipment system), the auditory signal may be triggered only when the controlled virtual object is moving. In this case, the step A1 may specifically include: acquiring the current state of the controlled virtual object; when the current state is a moving state, outputting the auditory signal of the target prompt intensity (for example, outputting the auditory signal of the prompt intensity into which the target distance falls; for another example, outputting the auditory signal of the prompt intensity within which the target angle falls).

In the step A2, a tactile signal of the target prompt intensity is output.

The tactile signal refers to a signal that can be felt through touch, such as vibration.

In some embodiments, the target prompt strength is a target distance prompt strength, and a tactile signal of the prompt strength into which the target distance falls (i.e., the target distance prompt strength) may be output so that the player can perceive the distance between the controlled virtual object and the target object detected by the detection tool through tactile information.

For example, as shown in Table 1, it is assumed that the preset distance prompt intensities include distance prompt intensities “level 3”, “level 2”, and “level 1” which are mapped to the target distances “short distance”, “medium distance”, and “long distance”, respectively. As shown in FIG. 6, the tactile representations corresponding to the distance prompt intensities “level 3”, “level 2”, and “level 1” are respectively as follows: “vibrating 1 time/s”, “vibrating 1 time/2 s”, and “no vibration”. If it is determined that the target distance is “short distance” in the step 203, the target distance prompt intensity in step 204 is the distance prompt intensity “level 3” which is mapped to “short distance”. In the step A1, the tactile representation “vibrating 1 time/s” corresponding to the target distance prompt intensity “level 3” may be output by the terminal device running the current game.

In some embodiments, the target prompt intensity is a target angle prompt intensity, and a tactile signal of the prompt strength within which the target angle falls (i.e., the target angle prompt intensity) may be output so that the player can perceive the angle between the controlled virtual object and the target object detected by the detection tool through tactile information.

For example, as shown in the Table 2, it is assumed that the preset angle prompt intensities include angle prompt intensities “level 2” and “level 1” which are respectively mapped to the target angles “near angle” and “far angle”. The tactile representations corresponding to the angle prompt intensities “level 2” and “level 1” are respectively as follows: “vibrating 1 time/s” and “no vibration”. If it is determined that the target angle is “near angle” in the step 203, the target distance prompt intensity in the step 204 is the angle prompt intensity “level 2” which is mapped to the “near angle”. In the step A1, the tactile representation “vibrating 1 time/s” corresponding to the target angle prompt intensity “level 2” may be output by the terminal device running the current game.

Furthermore, in order to ensure more accurate feedback of the orientation information between the controlled virtual object and the target object, such as the distance and angle between the controlled virtual object and the target object, upon detecting the movement instruction for the virtual object, the controlled virtual object may also be controlled to move in the game scene, and the orientation information may be updated according to the movement instruction. The display mode of the indication identifier may be controlled according to the updated orientation information. The method of “controlling the display mode of the indication identifier according to the updated orientation information” is similar to the step 204, and details may refer to the relevant description of the step 204, which will not be repeated herein.

Furthermore, in order to prevent the tactile signal from interfering with other non-exploratory operations (such as opening the equipment system), the tactile signal may be triggered only when the controlled virtual object is moving. In this case, the step A2 may specifically include: acquiring the current state of the controlled virtual object; when the current state is a moving state, outputting the tactile signal of the target prompt intensity (for example, outputting the tactile signal of the prompt strength into which the target distance falls; for another example, outputting the tactile signal of the prompt intensity within which the target angle falls).

Furthermore, in order to facilitate players in conveniently and quickly understanding the working status of the detection tool (such as a radar), the working status of the detection tool (such as the radar) may also be displayed through the scene thumbnail identifier. As shown in FIG. 7, (a) in FIG. 7 shows that the working status of the detection tool (such as the radar) is not displayed using the scene thumbnail identifier (such as a mini-map), which is illustrated in the rectangular dotted frame in (a) of FIG. 7; (b) in FIG. 7 shows that the working status of the detection tool (such as a radar) is displayed using the scene thumbnail identifier (such as the mini-map), which is illustrated in the rectangular dotted frame in (b) of FIG. 7. Specifically as follows.

Before the first skill is triggered, the indication identifier is displayed in a first preset display style. Thus, when the detection tool is in the off state, the scene thumbnail identifier (such as the mini-map of the current game) is displayed in one style.

During the cool down period of the first skill, the indication identifier is displayed in a second preset display style. Thus, when the detection tool is in the cooling state, the scene thumbnail identifier (such as the mini-map of the current game) is displayed in one style.

During the effective period of the first skill, if there is no target object within a preset range of the controlled virtual object, the indication identifier is displayed in a third preset display style. Thus, when the detection tool is in an activated state, the scene thumbnail identifier (such as the mini-map of the current game) is displayed in one style.

During the effective period of the first skill, if there is a target object within the preset range of the controlled virtual object, the indication identifier is displayed in a fourth preset display style. Thus, when the detection tool is in the exploration state, the scene thumbnail identifier (such as the mini-map of the current game) is displayed in one style. When the detection tool is in the exploration state, the detection signal of the detection tool may still be fed back through the indication identifier at the edge of the scene display area in the scene thumbnail identifier. The specific feedback manner may refer to the relevant description in the above step 204, which will not be repeated herein.

The first preset display style refers to the display style of the indication identifier at the edge of the scene display area in the scene thumbnail identifier before the first skill is triggered.

The second preset display style refers to the display style of the indication identifier at the edge of the scene display area in the scene thumbnail identifier during the cool down period of the first skill.

The third preset display style refers to the display style of the indication identifier at the edge of the scene display area in the scene thumbnail identifier when there is no target object within the preset range of the controlled virtual object during the effective period of the first skill.

The fourth preset display style refers to the display style of the indication identifier at the edge of the scene display area in the scene thumbnail identifier when a target object exists within the preset range of the controlled virtual object during the effective period of the first skill.

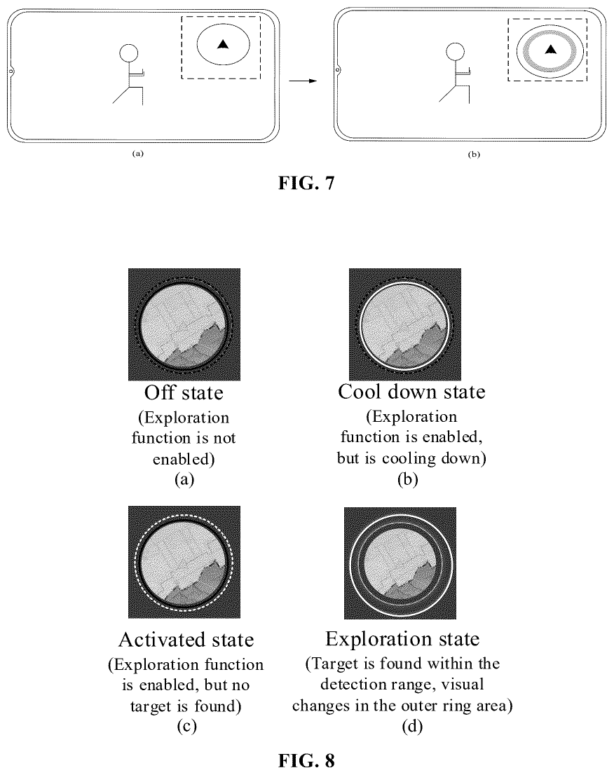

For example, as shown in FIG. 8, taking the first, second, third and fourth preset display styles as examples in which the outer frame of the mini-map presents the icon styles (a), (b), (c) and (d) in FIG. 8, respectively. When the detection tool is in the off state, the outer frame of the mini-map will present the icon style (a) in FIG. 8, that is, the outer frame of the mini-map presents a black solid line outer frame and a black dotted line outer frame. When the detection tool is in the cool down state, the outer frame of the mini-map will present the icon style (b) in FIG. 8, that is, the outer frame of the mini-map presents a white solid line outer frame and a black dotted line outer frame. When the detection tool is in the activated state, the outer frame of the mini-map will present the icon style (c) in FIG. 8, that is, the outer frame of the mini-map presents a black solid line outer frame and a white dotted line outer frame. When the detection tool is in the exploration state, the outer frame of the mini-map will present the icon style (d) in FIG. 8, that is, the outer frame of the mini-map presents at least two white solid line outer frames.

In this way, the working status of the detection tool is presented through changes in the display style of the indication identifier at the edge of the scene display area in the scene thumbnail identifier (such as the mini-map). On the one hand, it saves screen space and simplifies the game interface, especially for the game interface of mobile games, thereby improving the simplicity of the game interface, and further enhancing the convenience of game interaction operations on the basis of providing the player with the working status of the detection tool. On the other hand, since the mini-map is a permanent information panel on the main interface and is an important tool to assist the player in game exploration, presenting the working status of the detection tool through the mini-map enables the player to more quickly understand the presentation manner of the working status of the detection tool.

From the above content, it can be seen that, in the first aspect, when there is a target object in the game scene, the orientation information between the controlled virtual object and the target object is acquired, and the display mode of the indication identifier at the edge of the scene thumbnail identifier corresponding to the game scene is controlled according to the orientation information. Since the display mode of the indication identifier may be adjusted according to the orientation information, different visual signals can be generated as the orientation information between the controlled virtual object and the target object changes. In this way, the location information of the target object can be fed back to the player without directly feeding back the location information of the target object, which ensures that the player can accurately and gradually find the target object by using the detection signal, and improves the accuracy of the game signal feedback. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game. In the second aspect, the detection signal is displayed at the edge of the scene thumbnail identifier corresponding to the game scene displayed through the graphical user interface. Since there is no need to occupy additional screen space for the feedback of the game signal, the feedback of the game signal can save screen space, simplify the game interface, especially the game interface of mobile games, thereby improving the simplicity of the game interface, and further improving the convenience of game interaction operations on the basis of providing game signals to the player.

In order to better implement the above method, the embodiment of the present disclosure further provides a game signal feedback apparatus. The game signal feedback apparatus may be specifically integrated into an electronic device, such as a computer device, which may be a terminal, a server, or other such devices.

The terminal may be a mobile phone, a tablet computer, a smart Bluetooth device, a laptop computer, a personal computer and other devices; the server may be a single server or a server cluster composed of multiple servers.

For example, in this embodiment, the method in the embodiment of the present disclosure is described in detail by taking the game signal feedback apparatus being specifically integrated into a smart phone as an example.

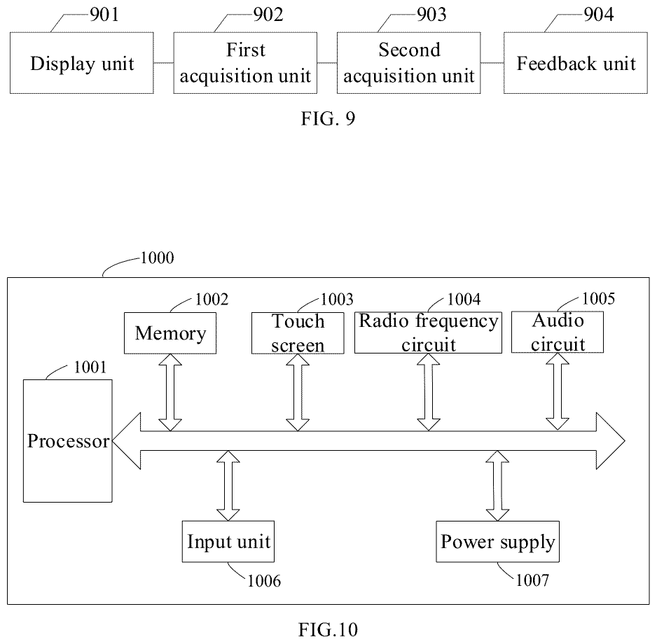

For example, as shown in FIG. 9, the game signal feedback apparatus may display a graphical user interface through a terminal device, where the graphical user interface includes a game scene and a controlled virtual object located in the game scene, and the controlled virtual object corresponds to the terminal device. The game signal feedback apparatus may include:
a display unit 901, configured to display a scene thumbnail identifier corresponding to the game scene through the graphical user interface, where the scene thumbnail includes a scene display area and an indication identifier, the scene display area displays a character identifier corresponding to the controlled virtual object, and the indication identifier is located at an edge of the scene display area;
a first acquisition unit 902, configured to acquire a sound source object in the game scene, and control to display prompt information corresponding to the sound source object in the scene display area;
a second acquisition unit 903, configured to acquire, when a target object exists in the game scene, orientation information between the controlled virtual object and the target object, where the target object is at least one of the following virtual objects: a virtual item and a virtual interactive object located in the game scene, where the virtual interactive object is configured to provide game information in response to an interactive behavior of the controlled virtual object; and
a feedback unit 904, configured to control a display mode of the indication identifier according to the orientation information.

In some embodiments, the second acquisition unit 903 is specifically configured to:
in response to a release instruction for a first skill, when the target object corresponding to the first skill exists in the game scene, acquire the orientation information between the controlled virtual object and the target object.

In some embodiments, the second acquisition unit 903 is specifically configured to:
in response to the release instruction for the first skill, detect whether the target object corresponding to the first skill exists in the game scene during an effective period of the first skill;
when the target object corresponding to the first skill exists in the game scene, acquire the orientation information between the controlled virtual object and the target object.

In some embodiments, the feedback unit 904 is specifically configured to:
in response to a movement instruction, control the controlled virtual object to move in the game scene, and update the orientation information according to the movement instruction; and
control the display mode of the indication identifier according to the updated orientation information.

In some embodiments, the orientation information includes a target distance between the controlled virtual object and the target object, and the feedback unit 904 is specifically configured to:
control to display, in a first prompt area of the indication identifier, a first visual signal associated with a prompt intensity into which the target distance falls.

In some embodiments, the feedback unit 904 is specifically configured to:
output an auditory signal of the prompt intensity into which the target distance falls; or
output a tactile signal of the prompt intensity into which the target distance falls.

In some embodiments, the feedback unit 904 is specifically configured to:
acquire a current state of the controlled virtual object; and
when the current state is a moving state, output the auditory signal of the prompt intensity into which the target distance falls.

In some embodiments, the feedback unit 904 is specifically configured to:
acquire a current state of the controlled virtual object; and
when the current state is a moving state, output the tactile signal of the prompt intensity into which the target distance falls.

In some embodiments, the orientation information includes a target angle between the controlled virtual object and the target object, and the feedback unit 904 is specifically configured to:
control to display, in a second prompt area of the indication identifier, a second visual signal associated with a prompt intensity within which the target angle falls.

In some embodiments, the second acquisition unit 903 is specifically configured to:
when the target object exists in the game scene, acquire a current angle between the controlled virtual object and the target object;
acquire a continuous movement distance of the controlled virtual object along the current angle; and
if the continuous movement distance is greater than or equal to a preset movement distance threshold, use the current angle as the target angle between the controlled virtual object and the target object.

In some embodiments, the second acquisition unit 903 is specifically configured to:
when the target object exists in the game scene, acquire a current angle between the controlled virtual object and the target object;
acquire a continuous movement duration of the controlled virtual object along the current angle;
if the continuous movement duration is greater than or equal to a preset movement duration threshold, use the current angle as the target angle between the controlled virtual object and the target object.

In some embodiments, the display unit is specifically configured to:
display the indication identifier in a first preset display style before a first skill is triggered; or
display the indication identifier in a second preset display style during a cool down period of the first skill; or
display the indication identifier in a third preset display style if no target object exists within a preset range of the controlled virtual object during an effective period of the first skill; or
display the indication identifier in a fourth preset display style if the target object exists within the preset range of the controlled virtual object during the effective period of the first skill.

In this way, the game signal feedback apparatus provided by the embodiment of the present disclosure can bring the following technical effects. In the first aspect, when there is a target object in the game scene, the orientation information between the controlled virtual object and the target object is acquired, and the display mode of the indication identifier at the edge of the scene thumbnail identifier corresponding to the game scene is controlled according to the orientation information. Since the display mode of the indication identifier may be adjusted according to the orientation information, different visual signals can be generated as the orientation information between the controlled virtual object and the target object changes. In this way, the location information of the target object can be fed back to the player without directly feeding back the location information of the target object, which ensures that the player can accurately and gradually find the target object by using the detection signal, and improves the accuracy of the game signal feedback. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game. In the second aspect, the detection signal is displayed at the edge of the scene thumbnail identifier corresponding to the game scene displayed through the graphical user interface. Since there is no need to occupy additional screen space for the feedback of the game signal, the feedback of the game signal can save screen space, simplify the game interface, especially the game interface of mobile games, thereby improving the simplicity of the game interface, and further improving the convenience of game interaction operations on the basis of providing game signals to the player.

Accordingly, an embodiment of the present disclosure further provides an electronic device, which may be a terminal, and the terminal may be a terminal device such as a smart phone, a tablet computer, a laptop computer, a touch screen, a game console, a personal computer (PC), a personal digital assistant (PDA), etc. As shown in FIG. 10, FIG. 10 is a schematic diagram of the structure of an electronic device provided in an embodiment of the present disclosure. The electronic device 1000 includes a processor 1001 having one or more processing cores, a memory 1002 having one or more computer-readable storage media, and computer programs stored in the memory 1002 and executable on the processor. The processor 1001 is electrically connected to the memory 1002. Those skilled in the art may understand that the electronic device structure shown in the figure does not constitute a limitation on the electronic device, and may include more or fewer components than those illustrated in the figure, or combine certain components, or have different component arrangements.

The processor 1001 is the control center of electronic device 1000. It connects various components of the entire electronic device 1000 through various interfaces and circuits. By running or loading software programs and/or modules stored in the memory 1002, and calling data stored in the memory 1002, the processor 1001 executes various functions of the electronic device 1000 and processes data, thereby providing overall monitoring of the electronic device 1000.

In an embodiment of the present disclosure, the processor 1001 in the electronic device 1000 may load instructions corresponding to the processes of one or more application programs into the memory 1002 according to the following steps, and the processor 1001 will run the application programs stored in the memory 1002 to implement various functions, such as:
displaying a scene thumbnail identifier corresponding to the game scene through the graphical user interface, where the scene thumbnail includes a scene display area and an indication identifier, the scene display area displays a character identifier corresponding to the controlled virtual object, and the indication identifier is located at an edge of the scene display area;
acquiring a sound source object in the game scene, and controlling to display prompt information corresponding to the sound source object in the scene display area;
when a target object exists in the game scene, acquiring orientation information between the controlled virtual object and the target object, where the target object is at least one of the following virtual objects: a virtual item and a virtual interactive object located in the game scene, where the virtual interactive object is configured to provide game information in response to an interactive behavior of the controlled virtual object; and
controlling a display mode of the indication identifier according to the orientation information.

In some embodiments, a step of acquiring the orientation information between the controlled virtual object and the target object when the target object exists in the game scene is: in response to a release instruction for a first skill, when the target object corresponding to the first skill exists in the game scene, acquiring the orientation information between the controlled virtual object and the target object.

In some embodiments, in response to the release instruction for the first skill, when the target object corresponding to the first skill exists in the game scene, a step of acquiring the orientation information between the controlled virtual object and the target object is:
in response to the release instruction for the first skill, detecting whether the target object corresponding to the first skill exists in the game scene during an effective period of the first skill;
when the target object corresponding to the first skill exists in the game scene, acquiring the orientation information between the controlled virtual object and the target object.

In some embodiments, the method further includes:
in response to a movement instruction, controlling the controlled virtual object to move in the game scene, and updating the orientation information according to the movement instruction; and
controlling the display mode of the indication identifier according to the updated orientation information.

In some embodiments, the orientation information includes a target distance between the controlled virtual object and the target object, and controlling the display mode of the indication identifier according to the orientation information includes:
controlling to display, in a first prompt area of the indication identifier, a first visual signal associated with a prompt intensity into which the target distance falls.

In some embodiments, the method further includes:
outputting an auditory signal of the prompt intensity into which the target distance falls; or
outputting a tactile signal of the prompt intensity into which the target distance falls.

In some embodiments, outputting the auditory signal of the prompt intensity into which the target distance falls includes:
acquiring a current state of the controlled virtual object;
when the current state is a moving state, outputting the auditory signal of the prompt intensity into which the target distance falls.

In some embodiments, outputting the tactile signal of the prompt intensity into which the target distance falls includes:
acquiring a current state of the controlled virtual object;
when the current state is a moving state, outputting the tactile signal of the prompt intensity into which the target distance falls.

In some embodiments, the orientation information includes a target angle between the controlled virtual object and the target object, and controlling the display mode of the indicator according to the orientation information includes:
controlling to display, in a second prompt area of the indication identifier, a second visual signal associated with a prompt intensity within which the target angle falls.

In some embodiments, when the target object exists in the game scene, acquiring the orientation information between the controlled virtual object and the target object includes:
when the target object exists in the game scene, acquiring a current angle between the controlled virtual object and the target object;
acquiring a continuous movement distance of the controlled virtual object along the current angle; and
if the continuous movement distance is greater than or equal to a preset movement distance threshold, using the current angle as the target angle between the controlled virtual object and the target object.

In some embodiments, when the target object exists in the game scene, acquiring the orientation information between the controlled virtual object and the target object includes:
when the target object exists in the game scene, acquiring a current angle between the controlled virtual object and the target object;
acquiring a continuous movement duration of the controlled virtual object along the current angle; and
if the continuous movement duration is greater than or equal to a preset movement duration threshold, using the current angle as the target angle between the controlled virtual object and the target object.

In some embodiments, the method further includes:
displaying the indication identifier in a first preset display style before a first skill is triggered; or
displaying the indication identifier in a second preset display style during a cool down period of the first skill; or
displaying the indication identifier in a third preset display style if no target object exists within a preset range of the controlled virtual object during an effective period of the first skill; or
displaying the indication identifier in a fourth preset display style if the target object exists within the preset range of the controlled virtual object during the effective period of the first skill.

In this way, the electronic device 1000 provided in this embodiment can bring the following technical effects. In the first aspect, when there is a target object in the game scene, the orientation information between the controlled virtual object and the target object is acquired, and the display mode of the indication identifier at the edge of the scene thumbnail identifier corresponding to the game scene is controlled according to the orientation information. Since the display mode of the indication identifier may be adjusted according to the orientation information, different visual signals can be generated as the orientation information between the controlled virtual object and the target object changes. In this way, the location information of the target object can be fed back to the player without directly feeding back the location information of the target object, which ensures that the player can accurately and gradually find the target object by using the detection signal, and improves the accuracy of the game signal feedback. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game. In the second aspect, the detection signal is displayed at the edge of the scene thumbnail identifier corresponding to the game scene displayed through the graphical user interface. Since there is no need to occupy additional screen space for the feedback of the game signal, the feedback of the game signal can save screen space, simplify the game interface, especially the game interface of mobile games, thereby improving the simplicity of the game interface, and further improving the convenience of game interaction operations on the basis of providing game signals to the player.

For the specific implementation of each of the above operations, reference may be made to the previous embodiments, which will not be repeated herein.

In some embodiments, as shown in FIG. 10, the electronic device 1000 further includes: a touch screen 1003, a radio frequency circuit 1004, an audio circuit 1005, an input unit 1006, and a power supply 1007. The processor 1001 is electrically connected to the touch screen 1003, the radio frequency circuit 1004, the audio circuit 1005, the input unit 1006, and the power supply 1007, respectively. Those skilled in the art may appreciate that the structure of the electronic device shown in FIG. 10 does not constitute a limitation on the electronic device. It may include more or fewer components than those illustrated in the figure, combine certain components, or have different component arrangements.

The touch display screen 1003 may be used to display a graphical user interface and receive operation instructions generated by the user through acting on the graphical user interface. The touch display screen 1003 may include a display panel and a touch panel. The display panel may be used to display information input by the user or information provided to the user and various graphical user interfaces of the electronic device, which may be composed of graphics, text, icons, videos and any combination thereof. In some embodiments, the display panel may be configured in the form of a liquid crystal display (LCD), an organic light-emitting diode (OLED), etc. The touch panel may be used to collect the user's touch operations on or near it (such as the user's operation on the touch panel or near the touch panel using any suitable object or accessory such as a finger, stylus, etc.), and generate corresponding operation instructions, and the operation instructions execute the corresponding programs. In some embodiments, the touch panel may include two parts, i.e., a touch detection apparatus and a touch controller. The touch detection apparatus detects the user's touch position, captures the signal brought by the touch operation, and transmits the signal to the touch controller. The touch controller receives the touch information from the touch detection apparatus, converts it into the touch point coordinate, and then sends it to the processor 1001. The touch controller can receive the command sent by the processor 1001 and execute the command. The touch panel may cover the display panel. When the touch panel detects a touch operation on or near it, it is transmitted to the processor 1001 to determine the type of touch event, and then the processor 1001 provides a corresponding visual output on the display panel according to the type of touch event. In the embodiment of the present disclosure, the touch panel and the display panel may be integrated into the touch display screen 1003 to realize the input and output functions. However, in some embodiments, the display panel and the touch panel may function as two independent components to realize the input and output functions. That is, the touch display screen 1003 may also serve as part of the input unit 1006 to implement input functions.

The radio frequency circuit 1004 may be used to send and receive radio frequency signals, so as to establish wireless communication with a network device or other electronic devices through wireless communication, and to send and receive signals with the network device or other electronic devices.

The audio circuit 1005 may be used to provide an audio interface between the user and the electronic device through a speaker and a microphone. The audio circuit 1005 may convert received audio data into electrical signals and transmit them to the speaker, and the speaker convert the electrical signals into sound signals for output. On the other hand, the microphone converts the collected sound signals into electrical signals, which are received by the audio circuit 1005 and converted into audio data. Then the audio data is output to the processor 1001 for processing, and then sent to another electronic device through the radio frequency circuit 1004, or the audio data is output to the memory 1002 for further processing. The audio circuit 1005 may also include an earplug jack to provide communication between an external headset and an electronic device.

The input unit 1006 may be used to receive input numerical and character information or user characteristic information (such as fingerprints, irises, facial information, etc.), and generate keyboard, mouse, joystick, optical, or trackball signal inputs related to user settings and functional controls.

The power supply 1007 is used to supply power to various components of the electronic device 1000. In some embodiments, the power supply 1007 may be logically connected to the processor 1001 through a power management system, so as to manage charging, discharging, and power consumption through the power management system. The power supply 1007 may further include one or more DC or AC power supplies, recharging systems, power failure detection circuits, power converters or inverters, power status indicators, and other arbitrary components.

Although not shown in FIG. 10, the electronic device 1000 may further include a camera, a sensor, a wireless fidelity module, a Bluetooth module, etc., which will not be described in detail herein.

In the above embodiments, the description of each embodiment has its own emphasis.

For parts that are not described in detail in a certain embodiment, reference may be made to the relevant descriptions of other embodiments.

Those of ordinary skill in the art may appreciate that all or part of the steps in the various methods of the above embodiments may be completed by instructions, or by controlling related hardware through the instructions. The instructions may be stored in a computer-readable storage medium and loaded and executed by a processor.

To this end, an embodiment of the present disclosure provides a computer-readable storage medium, in which a plurality of computer programs are stored, and the computer programs may be loaded by a processor to execute any one of the methods for game signal feedback provided in the embodiments of the present disclosure. For example, the computer program may execute the following steps of the game signal feedback method:
displaying a scene thumbnail identifier corresponding to the game scene through the graphical user interface, where the scene thumbnail includes a scene display area and an indication identifier, the scene display area displays a character identifier corresponding to the controlled virtual object, and the indication identifier is located at an edge of the scene display area;
acquiring a sound source object in the game scene, and controlling to display prompt information corresponding to the sound source object in the scene display area;
when a target object exists in the game scene, acquiring orientation information between the controlled virtual object and the target object, where the target object is at least one of the following virtual objects: a virtual item and a virtual interactive object located in the game scene, where the virtual interactive object is configured to provide game information in response to an interactive behavior of the controlled virtual object; and
controlling a display mode of the indication identifier according to the orientation information.

In some embodiments, a step of acquiring the orientation information between the controlled virtual object and the target object when the target object exists in the game scene is: in response to a release instruction for a first skill, when the target object corresponding to the first skill exists in the game scene, acquiring the orientation information between the controlled virtual object and the target object.

In some embodiments, in response to the release instruction for the first skill, when the target object corresponding to the first skill exists in the game scene, a step of acquiring the orientation information between the controlled virtual object and the target object is:
in response to the release instruction for the first skill, detecting whether the target object corresponding to the first skill exists in the game scene during an effective period of the first skill;
when the target object corresponding to the first skill exists in the game scene, acquiring the orientation information between the controlled virtual object and the target object.

In some embodiments, the method further includes:
in response to a movement instruction, controlling the controlled virtual object to move in the game scene, and updating the orientation information according to the movement instruction; and
controlling the display mode of the indication identifier according to the updated orientation information.

In some embodiments, the orientation information includes a target distance between the controlled virtual object and the target object, and controlling the display mode of the indication identifier according to the orientation information includes:
controlling to display, in a first prompt area of the indication identifier, a first visual signal associated with a prompt intensity within which the target distance falls.

In some embodiments, the method further includes:
outputting an auditory signal of the prompt intensity within which the target distance falls; or
outputting a tactile signal of the prompt intensity within which the target distance falls.

In some embodiments, outputting the auditory signal of the prompt intensity within which the target distance falls includes:
acquiring a current state of the controlled virtual object;
when the current state is a moving state, outputting the auditory signal of the prompt intensity within which the target distance falls.

In some embodiments, outputting the tactile signal of the prompt intensity within which the target distance falls includes:
acquiring a current state of the controlled virtual object;
when the current state is a moving state, outputting the tactile signal of the prompt intensity within which the target distance falls.

In some embodiments, the orientation information includes a target angle between the controlled virtual object and the target object, and controlling the display mode of the indicator according to the orientation information includes:
controlling to display, in a second prompt area of the indication identifier, a second visual signal associated with a prompt intensity within which the target angle falls.

In some embodiments, when the target object exists in the game scene, acquiring the orientation information between the controlled virtual object and the target object includes:
when the target object exists in the game scene, acquiring a current angle between the controlled virtual object and the target object;
acquiring a continuous movement distance of the controlled virtual object along the current angle; and
if the continuous movement distance is greater than or equal to a preset movement distance threshold, using the current angle as the target angle between the controlled virtual object and the target object.

In some embodiments, when the target object exists in the game scene, acquiring the orientation information between the controlled virtual object and the target object includes:
when the target object exists in the game scene, acquiring a current angle between the controlled virtual object and the target object;
acquiring a continuous movement duration of the controlled virtual object along the current angle; and
if the continuous movement duration is greater than or equal to a preset movement duration threshold, using the current angle as the target angle between the controlled virtual object and the target object.

In some embodiments, the method further includes:
displaying the indication identifier in a first preset display style before a first skill is triggered; or
displaying the indication identifier in a second preset display style during a cool down period of the first skill; or
displaying the indication identifier in a third preset display style if no target object exists within a preset range of the controlled virtual object during an effective period of the first skill; or
displaying the indication identifier in a fourth preset display style if the target object exists within the preset range of the controlled virtual object during the effective period of the first skill.

It can be seen that the computer program may be loaded by the processor to execute the steps in any one of the methods for game signal feedback provided in the embodiments of the present disclosure. Therefore, the computer-readable storage medium of the embodiment of the present disclosure can bring the following technical effects. In the first aspect, when there is a target object in the game scene, the orientation information between the controlled virtual object and the target object is acquired, and the display mode of the indication identifier at the edge of the scene thumbnail identifier corresponding to the game scene is controlled according to the orientation information. Since the display mode of the indication identifier may be adjusted according to the orientation information, different visual signals can be generated as the orientation information between the controlled virtual object and the target object changes. In this way, the location information of the target object can be fed back to the player without directly feeding back the location information of the target object, which ensures that the player can accurately and gradually find the target object by using the detection signal, and improves the accuracy of the game signal feedback. It avoids the problem that the precise location information of the target object is directly fed back to the player after the detection tool performs detection, which leads to the overly direct prompt for searching for objects, thus avoiding the problem that the active search for objects becomes passive search for objects due to the overly direct feedback mode, and improving the player's sense of immersion in the process of searching for objects in the game. In the second aspect, the detection signal is displayed at the edge of the scene thumbnail identifier corresponding to the game scene displayed through the graphical user interface. Since there is no need to occupy additional screen space for the feedback of the game signal, the feedback of the game signal can save screen space, simplify the game interface, especially the game interface of mobile games, thereby improving the simplicity of the game interface, and further improving the convenience of game interaction operations on the basis of providing game signals to the player.

For the specific implementation of each of the above operations, reference may be made to the previous embodiments, which will not be repeated herein.

The computer-readable storage medium may include: a read-only memory (ROM), a random access memory (RAM), a magnetic disk or an optical disk, etc.

In the above-mentioned embodiments of the game signal feedback apparatus, the computer-readable storage medium, and the electronic device, each embodiment is described with its own emphasis. For parts not detailed in a specific embodiment, reference may be made to the relevant descriptions in other embodiments. Those skilled in the art can clearly understand that, for the sake of convenience and conciseness in description, the specific working processes and beneficial effects of the game signal feedback apparatus device, the computer-readable storage medium, the electronic device and corresponding units thereof in the above description may refer to the descriptions of the game signal feedback methods in the above embodiments, and will not be repeated herein.

The above has provided a detailed introduction to the game signal feedback method and apparatus, the electronic device, and the computer-readable storage medium provided by the embodiments of the present disclosure. Specific examples have been used herein to elaborate the principles and implementation manners of the present disclosure. The descriptions of the above embodiments are only intended to help understand the method of the present disclosure and its core ideas. Meanwhile, for those skilled in the art, based on the ideas of the present disclosure, there will be changes in specific implementation manners and application scopes. In conclusion, the content of this specification should not be construed as a limitation to the present disclosure.

1. A game signal feedback method, comprising:
displaying, by a terminal device, a scene thumbnail identifier corresponding to a game scene through a graphical user interface, wherein the scene thumbnail comprises a scene display area and an indication identifier, the scene display area displays a character identifier corresponding to a controlled virtual object, and the indication identifier is located at an edge of the scene display area, and wherein the graphical user interface is displayed through the terminal device, the graphical user interface comprises the game scene and the controlled virtual object located in the game scene, and the controlled virtual object corresponds to the terminal device;
acquiring, by the terminal device, a sound source object in the game scene, and controlling to display prompt information corresponding to the sound source object in the scene display area; in response to determining that a target object exists in the game scene, acquiring, by the terminal device, orientation information between the controlled virtual object and the target object, wherein the target object comprises at least one of following virtual objects: a virtual item or a virtual interactive object located in the game scene, wherein the virtual interactive object is configured to provide game information in response to an interactive behavior of the controlled virtual object; and
controlling, by the terminal device, a display mode of the indication identifier according to the orientation information.

2. The game signal feedback method according to claim 1, wherein acquiring the orientation information between the controlled virtual object and the target object in response to determining that the target object exists in the game scene comprises: in response to a release instruction for a first skill, and in response to determining that the target object corresponding to the first skill exists in the game scene, acquiring the orientation information between the controlled virtual object and the target object.

3. The game signal feedback method according to claim 2, wherein in response to the release instruction for the first skill, and in response to determining that the target object corresponding to the first skill exists in the game scene, acquiring the orientation information between the controlled virtual object and the target object comprises: in response to the release instruction for the first skill, detecting whether the target object corresponding to the first skill exists in the game scene within an effective period of the first skill; and
in response to determining that the target object corresponding to the first skill exists in the game scene, acquiring the orientation information between the controlled virtual object and the target object.

4. The game signal feedback method according to claim 1, wherein the method further comprises:
in response to a movement instruction, controlling the controlled virtual object to move in the game scene, and updating the orientation information according to the movement instruction; and
controlling the display mode of the indication identifier according to the updated orientation information.

5. The game signal feedback method according to claim 1, wherein the orientation information comprises a target distance between the controlled virtual object and the target object, and controlling the display mode of the indication identifier according to the orientation information comprises:
controlling to display, in a first prompt area of the indication identifier, a first visual signal associated with a prompt intensity into which the target distance falls.

6. The game signal feedback method according to claim 5, wherein the method further comprises:
outputting an auditory signal of the prompt intensity into which the target distance falls; or
outputting a tactile signal of the prompt intensity into which the target distance falls.

7. The game signal feedback method according to claim 6, wherein
outputting the auditory signal of the prompt intensity into which the target distance falls comprises:
acquiring a current state of the controlled virtual object; and
in response to determining that the current state is a moving state, outputting the auditory signal of the prompt intensity into which the target distance falls.

8. The game signal feedback method according to claim 6, wherein
outputting the tactile signal of the prompt intensity into which the target distance falls comprises:
acquiring a current state of the controlled virtual object; and
in response to determining that the current state is a moving state, outputting the tactile signal of the prompt intensity into which the target distance falls.

9. The game signal feedback method according to claim 1, wherein the orientation information comprises a target angle between the controlled virtual object and the target object, and controlling the display mode of the indication identifier according to the orientation information comprises:
controlling to display, in a second prompt area of the indication identifier, a second visual signal associated with a prompt intensity into which the target angle falls.

10. The game signal feedback method according to claim 9, wherein
in response to determining that the target object exists in the game scene, acquiring the orientation information between the controlled virtual object and the target object comprises:
in response to determining that the target object exists in the game scene, acquiring a current angle between the controlled virtual object and the target object;
acquiring a continuous movement distance of the controlled virtual object along the current angle; and
in response to determining that the continuous movement distance is greater than or equal to a preset movement distance threshold, using the current angle as the target angle between the controlled virtual object and the target object.

11. The game signal feedback method according to claim 9, wherein
in response to determining that the target object exists in the game scene, acquiring the orientation information between the controlled virtual object and the target object comprises:
in response to determining that the target object exists in the game scene, acquiring a current angle between the controlled virtual object and the target object;
acquiring a continuous movement duration of the controlled virtual object along the current angle; and
in response to determining that the continuous movement duration is greater than or equal to a preset movement duration threshold, using the current angle as the target angle between the controlled virtual object and the target object.

12. The game signal feedback method according to claim 1, wherein the method further comprises:
displaying the indication identifier in a first preset display style before a first skill is triggered; or
displaying the indication identifier in a second preset display style during a cool down period of the first skill; or
displaying the indication identifier in a third preset display style in response to determining that no target object exists within a preset range of the controlled virtual object during an effective period of the first skill; or
displaying the indication identifier in a fourth preset display style in response to determining that the target object exists within the preset range of the controlled virtual object during the effective period of the first skill.

13. (canceled)

14. An electronic device, comprising a processor and a memory, wherein
the memory stores a plurality of instructions, the processor loads the plurality of instructions from the memory to:
display a scene thumbnail identifier corresponding to a game scene through a graphical user interface, wherein the scene thumbnail comprises a scene display area and an indication identifier, the scene display area displays a character identifier corresponding to a controlled virtual object, and the indication identifier is located at an edge of the scene display area, and wherein the graphical user interface is displayed through the electronic device, the graphical user interface comprises the game scene and the controlled virtual object located in the game scene, and the controlled virtual object corresponds to the electronic device;
acquire a sound source object in the game scene, and controlling to display prompt information corresponding to the sound source object in the scene display area;
in response to determining that a target object exists in the game scene, acquire orientation information between the controlled virtual object and the target object, wherein the target object is at least one of following virtual objects: a virtual item or a virtual interactive object located in the game scene, wherein the virtual interactive object is configured to provide game information in response to an interactive behavior of the controlled virtual object; and
control a display mode of the indication identifier according to the orientation information.

15. A non-transitory computer-readable storage medium, wherein the computer-readable storage medium stores a plurality of instructions, wherein the plurality of instructions are suitable for being loaded by a processor to:
display a scene thumbnail identifier corresponding to a game scene through a graphical user interface, wherein the scene thumbnail comprises a scene display area and an indication identifier, the scene display area displays a character identifier corresponding to a controlled virtual object, and the indication identifier is located at an edge of the scene display area, and wherein the graphical user interface is displayed through a terminal device, the graphical user interface comprises the game scene and the controlled virtual object located in the game scene, and the controlled virtual object corresponds to the terminal device:
acquire a sound source object in the game scene, and controlling to display prompt information corresponding to the sound source object in the scene display area;
in response to determining that a target object exists in the game scene, acquire orientation information between the controlled virtual object and the target object, wherein the target object comprises at least one of following virtual objects: a virtual item or a virtual interactive object located in the game scene, wherein the virtual interactive object is configured to provide game information in response to an interactive behavior of the controlled virtual object; and
control a display mode of the indication identifier according to the orientation information.

16. The game signal feedback method according to claim 5, wherein controlling to display, in the first prompt area of the indication identifier, the first visual signal associated with the prompt intensity into which the target distance falls, comprises:
determining a target distance prompt intensity into which the target distance falls from preset distance prompt intensities; and
displaying the first visual signal associated with the prompt intensity into which the target distance falls in the first prompt area of the indication identifier.

17. The game signal feedback method according to claim 16, wherein the preset distance prompt intensities comprise a plurality of levels, and the distance prompt intensities with different levels are used to reflect different target distances.

18. The game signal feedback method according to claim 9, wherein controlling to display, in the second prompt area of the indication identifier, the second visual signal associated with the prompt intensity into which the target angle falls, comprises:
determining a target angle prompt intensity within which the target angle falls from preset angle prompt intensities; and
displaying the second visual signal associated with the prompt intensity into which the target angle falls in the second prompt area of the indication identifier.

19. The game signal feedback method according to claim 18, wherein the preset angle prompt intensities comprise a plurality of levels, and the angle prompt intensities with different levels are used to reflect different target angles.

20. The game signal feedback method according to claim 1, wherein the orientation information comprises a target distance between the controlled virtual object and the target object and a target angle between the controlled virtual object and the target object, and controlling the display mode of the indication identifier according to the orientation information comprises:
controlling to display, in a first prompt area of the indication identifier, a first visual signal associated with a prompt intensity into which the target distance falls; and
controlling to display, in a second prompt area of the indication identifier, a second visual signal associated with a prompt intensity into which the target angle falls.

21. The electronic device according to claim 14, wherein the processor is further configured to:
in response to a release instruction for a first skill, and in response to determining that the target object corresponding to the first skill exists in the game scene, acquire the orientation information between the controlled virtual object and the target object.
